(19) United States
(12) Patent Application Publication
(10) Pub. No.: US 2017/0069124 A1
(43) Pub. Date: Mar. 9, 2017

(54) AVATAR GENERATION AND ANIMATIONS

(71) Applicant: Intel Corporation, Santa Clara, CA (US)

(72) Inventors: Xiaofeng TONG, Beijing (CN); Wenlong LI, Beijing (CN); Xiaolu SHEN, Beijing (CN); Lidan ZHANG, Beijing (CN); Qiang LI, Beijing (CN)

(21) Appl. No.: 14/916,550

(22) PCT Filed: Apr. 7, 2015
(86) PCT No.: PCT/CN2015/075988

§ 371 Date: Mar. 3, 2016

(51) Int. Cl. G06T 13/40; G06T 17/20

(52) U.S. Cl. CPC G06T 13/40; G06T 17/20

(57) ABSTRACT

Apparatuses, methods and storage medium associated with generating and animating avatars are disclosed herein. In embodiments, an apparatus may comprise an avatar generator to receive an image having a face of a user; analyze the image to identify various facial and related components of the user; access an avatar database to identify corresponding artistic renditions for the various facial and related components stored in the database; and combine the corresponding artistic renditions for the various facial and related components to form an avatar, without user intervention. In embodiments, the apparatus may further comprise an avatar animation engine to animate the avatar in accordance with a plurality of animation messages having facial expression or head pose parameters that describe facial expressions or head poses of a user determined from an image of the user. Other embodiments may be disclosed and/or claimed.

### TECHNICAL FIELD

The present disclosure relates to the field of data processing. More particularly, the present disclosure relates to generation and animation of avatars.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

As user's graphic representation, avatar has been quite popular in virtual world. However, most existing avatar systems are static, and few of them are driven by text, script or voice. Some other avatar systems use graphics interchange format (GIF) animation, which is a set of predefined static avatar image playing in sequence. In recent years, with the advancement of computer vision, camera, image processing, etc., some avatar may be driven by facial expressions. However, existing systems tend to be computation intensive, requiring high-performance general and graphics processor, and generally do not work well on mobile devices, such as smartphones or computing tablets. Further, existing systems do not provide facilities for creating personalized avatars. In particular, there are no known two dimensional (2D) avatar systems that provide for both automated creation of personalized avatars and animation of the created avatars.

### BRIEF DESCRIPTION OF THE DRAWINGS

Embodiments for generation and animation of avatars will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of an avatar system, according to various embodiments.

FIG. 2 illustrates a layer structure for forming an avatar, according to various embodiments.

FIG. 3 illustrates the avatar database of FIG. 1, and its access in further detail, according to various embodiments.

FIG. 4 illustrates an example process for automatically generating a personalized avatar, according to various embodiments.

FIG. 5 illustrates various example personalized avatars, according to various embodiments.

FIG. 6 illustrates the facial expression tracking function of FIG. 1 in further detail, according to various embodiments.

FIG. 7 illustrates an example process for animating an avatar, according to various embodiments.

FIG. 8 illustrates a sparse mesh and a dense mesh employed in the process of animating an avatar, according to various embodiments.

FIG. 9 illustrates an example computer system suitable for use to practice various aspects of the present disclosure, according to the disclosed embodiments.

FIG. 10 illustrates a storage medium having instructions for practicing methods described with references to FIGS. 1-8, according to disclosed embodiments.

### DETAILED DESCRIPTION

Apparatuses, methods and storage medium associated with generating and animating avatars are disclosed herein. In embodiments, an apparatus may comprise an avatar generator to receive an image having a face of a user; analyze the image to identify various facial and related components of the user; access an avatar database to identify corresponding artistic renditions for the various facial and related components stored in the database; and combine the corresponding artistic renditions for the various facial and related components to form an avatar, without user intervention.

In embodiments, the apparatus may further comprise an avatar animation engine to animate the avatar in accordance with a plurality of animation messages having facial expression or head pose parameters that describe facial expressions or head poses of a user determined from an image of the user. The avatar animation engine may be configured to, as part of animation of the avatar, generate a deformed mesh for the avatar, from a template mesh; and transfer a plurality of blend shapes associated with the template mesh to the deformed mesh.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

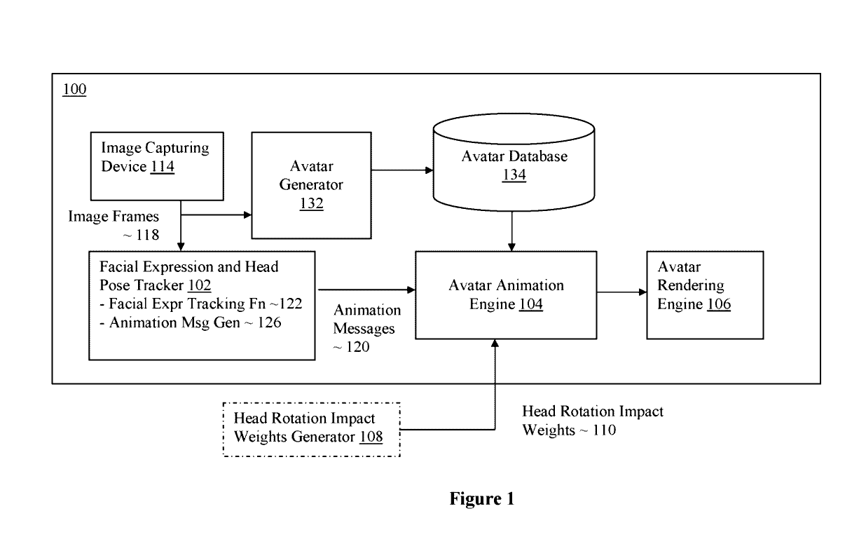

Referring now to FIG. 1, wherein an avatar system, according to the disclosed embodiments, is shown. As illustrated, in embodiments, avatar system 100 for efficient generation and animation of avatars may include avatar generator 132 and avatar database 134, coupled with each other, and configured to automatically generate a personalized avatar for a user, based at least in part on an image frame (or simply “image”) 118 of the user. Further, avatar system 100 may include facial expression and head pose tracker 102, avatar animation engine 104, and avatar rendering engine 106, coupled with each other, and configured to animate avatars, including the personalized avatars generated by avatar generator 132 (in cooperation with avatar database 134).

In embodiments, avatar generator 132 may be configured to receive an image 118 of a user having a face of the user, e.g., from image capturing device 114, such as, a camera, analyze the image for a number of facial and related components, access avatar database 134 to identify corresponding artist renditions of the facial components; and form the personalized avatar based at least in part of the artist renditions of the facial components identified, without user intervention.

In embodiments, facial expression and head pose tracker 102 may be configured to receive one or more image frames 118 of a user, from image capturing device 114, such as, a camera. Facial expression and head pose tracker 102 may analyze image frames 118 for facial expressions of the user, including head poses of the user. Still further, facial expression and head pose tracker 102 may be configured to output a plurality animation messages to drive animation of an avatar, based on the determined facial expressions and head poses of the user.

In embodiments, for efficiency of operation, avatar system 100 may be configured to animate an avatar with a plurality of pre-defined blend shapes, making avatar system 100 particularly suitable for a wide range of mobile devices. A model with neutral expression and some typical expressions, such as mouth open, mouth smile, brow-up, and brow-down, blink, etc., may be first pre-constructed, in advance. The blend shapes may be decided or selected for various facial expression and head pose tracker 102 capabilities and target mobile device system requirements. During operation, facial expression and head pose tracker 102 may select various blend shapes, and assign the blend shape weights, based on the facial expression and/or head poses determined. The selected blend shapes and their assigned weights may be output as part of animation messages 120.

On receipt of the blend shape selection, and the blend shape weights (αᵢ), avatar animation engine 104 may generate the expressed facial results with the following formula (Eq. 1):

$${B}^{*} = {B}_{0} + {\sum }_{i} {α}_{i} \cdot Δ {B}_{i}$$

where B* is the target expressed facial,
B₀ is the base model with neutral expression, and
ΔBᵢ is i^{th} blend shape that stores the vertex position offset based on base model for specific expression.

More specifically, in embodiments, facial expression and head pose tracker 102 may be configured with facial expression tracking function 122 and animation message generation function 126. In embodiments, facial expression tracking function 122 may be configured to detect facial action movements of a face of a user and/or head pose gestures of a head of the user, within the plurality of image frames, and output a plurality of facial parameters that depict the determined facial expressions and/or head poses, in real time. For examples, the plurality of facial motion parameters may depict facial action movements detected, such as, eye and/or mouth movements, and/or head pose gesture parameters that depict head pose gestures detected, such as head rotation, movement, and/or coming closer or farther from the camera.

In embodiments, facial action movements and head pose gestures may be detected, e.g., through inter-frame differences for a mouth and an eye on the face, and the head, based on pixel sampling of the image frames. Various ones of the function blocks may be configured to calculate rotation angles of the user's head, including pitch, yaw and/or roll, and translation distance along horizontal, vertical direction, and coming closer or going farther from the camera, eventually output as part of the head pose gesture parameters. The calculation may be based on a subset of sub-sampled pixels of the plurality of image frames, applying, e.g., dynamic template matching, re-registration, and so forth. These function blocks may be sufficiently accurate, yet scalable in their processing power required, making avatar system 100 particularly suitable to be hosted by a wide range of mobile computing devices, such as smartphones and/or computing tablets.

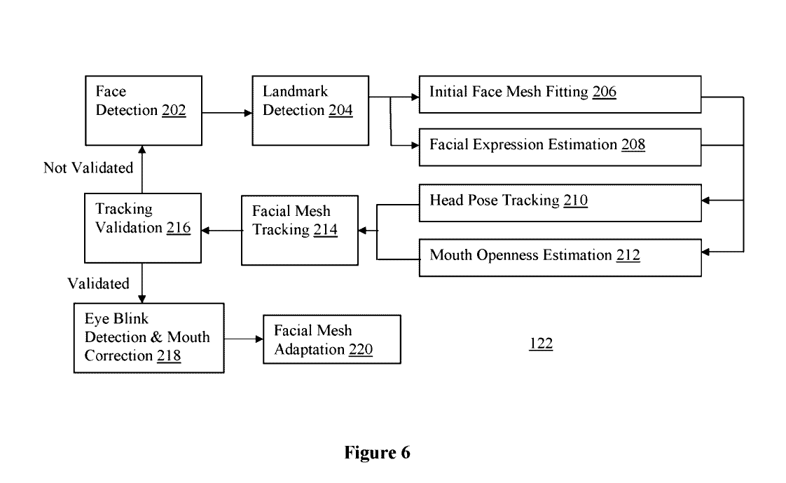

An example facial expression tracking function 122 will be further described later with references to FIG. 6.

In embodiments, animation message generation function 126 may be configured to selectively output animation messages 120 to drive animation of an avatar, based on the facial expression and head pose parameters depicting facial expressions and head poses of the user. In embodiments, animation message generation function 126 may be configured to convert facial action units into blend shapes and their assigned weights for animation of an avatar. Since face tracking may use different mesh geometry and animation structure with avatar rendering side, animation message generation function 126 may also be configured to perform animation coefficient conversion and face model retargeting. In embodiments, animation message generation function 126 may output the blend shapes and their weights as animation messages 120. Animation message 120 may specify a number of animations, such as “lower lip down” (LLIPD), “both lips widen” (BLIPW), “both lips up” (BLIPU), “nose wrinkle” (NOSEW), “eyebrow down” (BROWD), and so forth.

Still referring to FIG. 1, avatar animation engine 104 may be configured to receive animation messages 120 outputted by facial expression and head pose tracker 102, and drive an avatar model to animate the avatar, to replicate facial expressions and/or speech of the user on the avatar. Avatar rendering engine 106 may be configured to draw the avatar as animated by avatar animation engine 104.

Facial expression and head pose tracker 102, avatar animation engine 104 and avatar rendering engine 106, may each be implemented in hardware, e.g., Application Specific Integrated Circuit (ASIC) or programmable devices, such as Field Programmable Gate Arrays (FPGA) programmed with the appropriate logic, software to be executed by general and/or graphics processors, or a combination of both.

Compared with other facial animation techniques, such as motion transferring and mesh deformation, using blend shape for facial animation may have several advantages: 1) Expressions customization: expressions may be customized according to the concept and characteristics of the avatar, when the avatar models are created. The avatar models may be made more funny and attractive to users. 2) Low computation cost: the computation may be configured to be proportional to the model size, and made more suitable for parallel processing. 3) Good scalability: addition of more expressions into the framework may be made easier.

It will be apparent to those skilled in the art that these features, individually and in combination, make avatar system 100 particularly suitable to be hosted by a wide range of mobile computing devices. However, while avatar system 100 is designed to be particularly suitable to be operated on a mobile device, such as a smartphone, a phablet, a computing tablet, a laptop computer, or an e-reader, the disclosure is not to be so limited. It is anticipated that avatar system 100 may also be operated on computing devices with more computing power than the typical mobile devices, such as a desktop computer, a game console, a set-top box, or a computer server. The foregoing and other aspects of pocket avatar system 100 will be described in further detail in turn below.

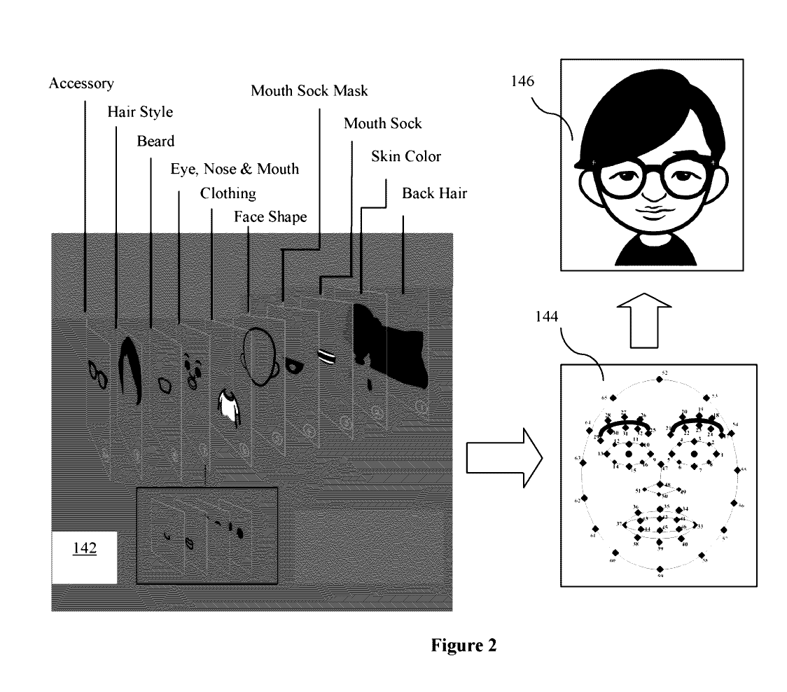

Referring now to FIG. 2, wherein a layer structure for forming an avatar, according to various embodiments, is shown. As illustrated, each avatar 146 may be formed by applying a plurality of component layers 142 to a templet mesh 144. Each of the component layers 142 may include one or more facial and/or related components, and their positions. Examples of the facial and/or related components may include, but are not limited to, accessories, such as, eyeglasses, hair style, beard, clothing, face shape, mouth sock mask, mouth sock, skin color, back hair, and so forth. In embodiments, the template mesh 144 may include a number of pre-defined landmarks, 65 for the illustrated embodiment. In association with the template mesh 144 may be a number of blend shapes, e.g., 18.

Hereinafter, for ease of description, facial and related components may be simply referred to as facial components; however, unless the context clearly indicates otherwise, the term is to include related components, such as eyeglasses, clothing, skin color, and so forth.

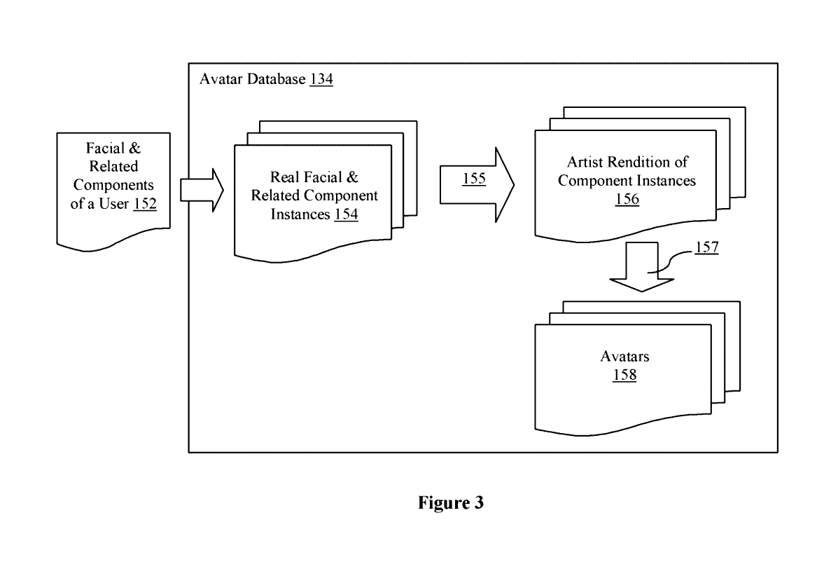

Referring now to FIG. 3, wherein the avatar database of FIG. 1 and its access, according to various embodiments, are illustrated. A number of real facial component instances 154 (such as, eye, nose, mouth, hair . . . instances, and so forth) and a number of artistic renditions of these facial component instances 156 are stored in avatar database 134. The artistic renditions of the various facial component instances 156 may be of the same or different cartoon styles. Prior to operation, mappings 155 between the real facial component instances 154 and the artistic renditions of these facial component instances 156 may be established. For example, an artist or an administrator may map Real_Hair_1 and Real_Hair_3 to Artistic_Rendition_Hair_1, and Real_Hair_2 to Artistic_Rendition_Hair_2.

During operation, the facial components of a user 152 may be extracted from similar landmarks in the face of a user. In embodiments, avatar generator 132 may be configured to first extract facial part image patches from auto-detected face landmarks. Additionally, avatar generator 132 may be further configured to extract visual features (such as geometrical shape, patch grayness, Histogram of Gradient (HOG)) from the extracted patches, to identify the facial components of a user 152.

On identification, the facial components of a user 152 may be used as inputs to access avatar database 134 to first identify the similar (e.g. closest) real facial component instances 154 stored therein. Thus, the real facial component instances 154 may be considered as reference facial component instances 154. In embodiments, the effectiveness of identifying real facial component instances 154 stored that are similar (e.g., closest) to the inputting facial components of the users 152 may be improved over time through application of a machine learning process.

On identification of reference facial component instances 154 that are considered to be similar (or closest) to the facial components of a user 152, avatar database 134 may be further accessed to identify the corresponding artistic renditions of the facial components 156, following the mappings 155 pre-established prior to operation.

On identification of the corresponding artistic renditions of the facial components 156, the corresponding artistic renditions of the facial components 156 may then be combined 157 to form a personalized avatar 158 for the user. In embodiments, personalized avatars 158 may also be stored in avatar database 134.

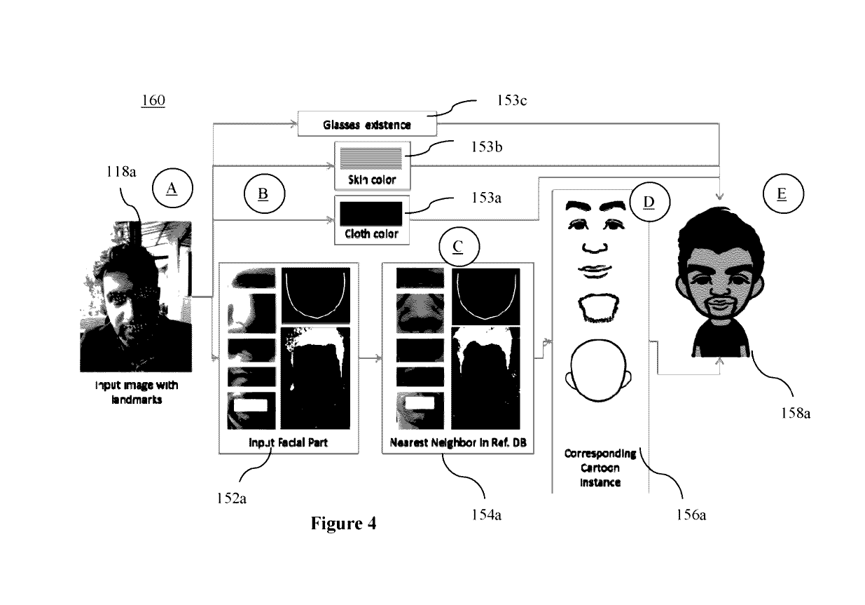

Referring now to FIG. 4, an example process for automatically generating a personalized avatar, according to various embodiments, is shown. As illustrated and described earlier, process 160 for automatically generating a personalized avatar may comprise the operations performed at blocks A-E. The operations may be performed e.g., by avatar generator 132 of FIG. 1.

Process 160 for automatically generating a personalized avatar may start at point A, with receiving an image 118a having a face of a user. Next, at point B, image 118a may be analyzed to identify the facial components of the user. Using, a set of facial landmarks, various facial components of the user, facial parts 152a and related attributes (eyeglasses, skin color, clothing color) 153a-153c may be identified. In embodiments, for color determination, the skin and cloth regions may first be cropped. Cropping may be performed using image segmentation methods and prior knowledge of facial landmarks. Then, the color of each region may be estimated using Gaussian Mixture Model (GMM) in a red/green/blue (RGB) space. In embodiments, regions below and between the eyes may be analyzed to distinguish whether an eyeglass exists. These two regions may first be cropped and their edges may be calculated using an edge detection algorithm. The edge ratio may then be calculated to determine the presence of an eyeglass.

Then at point C, a number of similar (or closest) reference facial components 154a may be identified for the facial parts 152a and related attributes 153a-153c identified.

At point D, the corresponding artistic renditions 156a of the similar (or closest) reference facial components 154a may be identified (e.g., based on the pre-established mappings between the reference facial components 154a and the artistic renditions of the facial components 156.)

At point E, the artistic renditions of the facial components 156 may be combined (e.g., applying to a template mesh as earlier described) to form the personalized avatar 158a for the user.

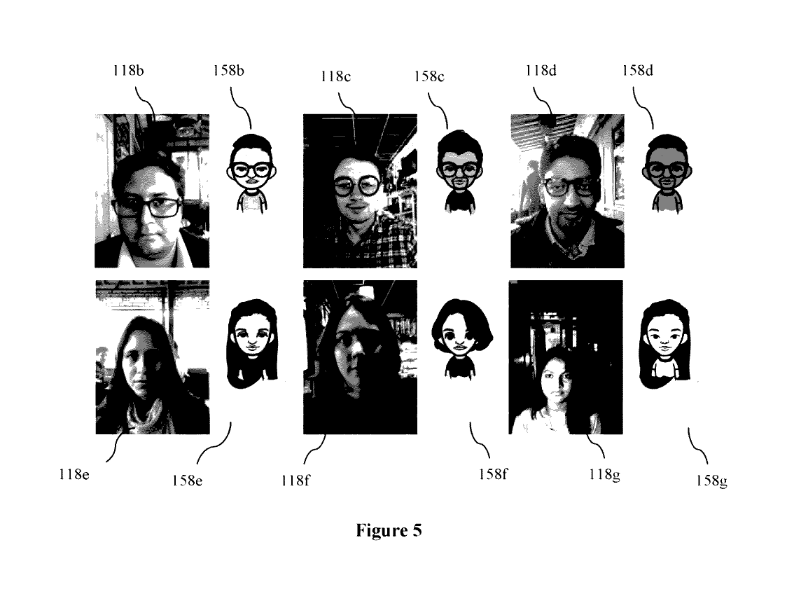

FIG. 5 illustrates various example personalized avatars 158b-158g automatically generated for various users 118b-118b, using the process described. Thus, under the present disclosure, the personalized avatars 158 may be artistic renditions of real persons that reassemble the user, and therefore, may resemble the user himself/herself.

Referring now to FIG. 6, wherein an example implementation of the facial expression tracking function 122 of FIG. 1 is illustrated in further detail, according to various embodiments. As shown, in embodiments, facial expression tracking function 122 may include face detection function block 202, landmark detection function block 204, initial face mesh fitting function block 206, facial expression estimation function block 208, head pose tracking function block 210, mouth openness estimation function block 212, facial mesh tracking function block 214, tracking validation function block 216, eye blink detection and mouth correction function block 218, and facial mesh adaptation block 220 coupled with each other as shown.

In embodiments, face detection function block 202 may be configured to detect the face through window scan of one or more of the plurality of image frames received. At each window position, modified census transform (MCT) features may be extracted, and a cascade classifier may be applied to look for the face. Landmark detection function block 204 may be configured to detect landmark points on the face, e.g., eye centers, nose-tip, mouth corners, and face contour points. Given a face rectangle, an initial landmark position may be given according to mean face shape. Thereafter, the exact landmark positions may be found iteratively through an explicit shape regression (ESR) method.

In embodiments, initial face mesh fitting function block 206 may be configured to initialize a 3D pose of a face mesh based at least in part on a plurality of landmark points detected on the face. A Candide3 wireframe head model may be used. The rotation angles, translation vector and scaling factor of the head model may be estimated using the POSIT algorithm. Resultantly, the projection of the 3D mesh on the image plane may match with the 2D landmarks. Facial expression estimation function block 208 may be configured to initialize a plurality of facial motion parameters based at least in part on a plurality of landmark points detected on the face. The Candide3 head model may be controlled by facial action parameters (FAU), such as mouth width, mouth height, nose wrinkle, eye opening. These FAU parameters may be estimated through least square fitting.

Head pose tracking function block 210 may be configured to calculate rotation angles of the user's head, including pitch, yaw and/or roll, and translation distance along horizontal, vertical direction, and coming closer or going farther from the camera. The calculation may be based on a subset of sub-sampled pixels of the plurality of image frames, applying dynamic template matching and re-registration. Mouth openness estimation function block 212 may be configured to calculate opening distance of an upper lip and a lower lip of the mouth. The correlation of mouth geometry (opening/closing) and appearance may be trained using a sample database. Further, the mouth opening distance may be estimated based on a subset of sub-sampled pixels of a current image frame of the plurality of image frames, applying FERN regression.

Facial mesh tracking function block 214 may be configured to adjust position, orientation or deformation of a face mesh to maintain continuing coverage of the face and reflection of facial movement by the face mesh, based on a subset of sub-sampled pixels of the plurality of image frames. The adjustment may be performed through image alignment of successive image frames, subject to pre-defined FAU parameters in Candide3 model. The results of head pose tracking function block 210 and mouth openness may serve as soft-constraints to parameter optimization. Tracking validation function block 216 may be configured to monitor face mesh tracking status, to determine whether it is necessary to re-locate the face. Tracking validation function block 216 may apply one or more face region or eye region classifiers to make the determination. If the tracking is running smoothly, operation may continue with next frame tracking, otherwise, operation may return to face detection function block 202, to have the face re-located for the current frame.

Eye blink detection and mouth correction function block 218 may be configured to detect eye blinking status and mouth shape. Eye blinking may be detected through optical flow analysis, whereas mouth shape/movement may be estimated through detection of inter-frame histogram differences for the mouth. As refinement of whole face mesh tracking, eye blink detection and mouth correction function block 216 may yield more accurate eye-blinking estimation, and enhance mouth movement sensitivity.

Face mesh adaptation function block 220 may be configured to reconstruct a face mesh according to derived facial action units, and re-sample of a current image frame under the face mesh to set up processing of a next image frame.

Example facial expression tracking function 122 is the subject of co-pending patent application, PCT Patent Application No. PCT/CN2014/073695, entitled “FACIAL EXPRESSION AND/OR INTERACTION DRIVEN AVATAR APPARATUS AND METHOD,” filed Mar. 19, 2014. As described, the architecture, distribution of workloads among the functional blocks render facial expression tracking function 122 particularly suitable for a portable device with relatively more limited computing resources, as compared to a laptop or a desktop computer, or a server. For further details, refer to PCT Patent Application No. PCT/CN2014/073695.

In alternate embodiments, facial expression tracking function 122 may be any one of a number of other face trackers known in the art.

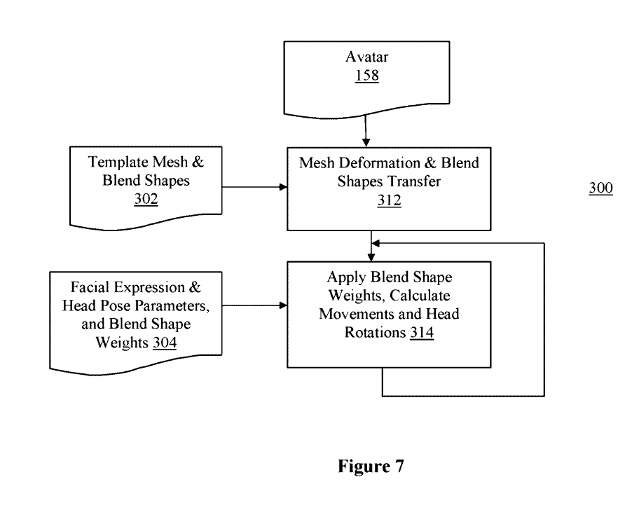

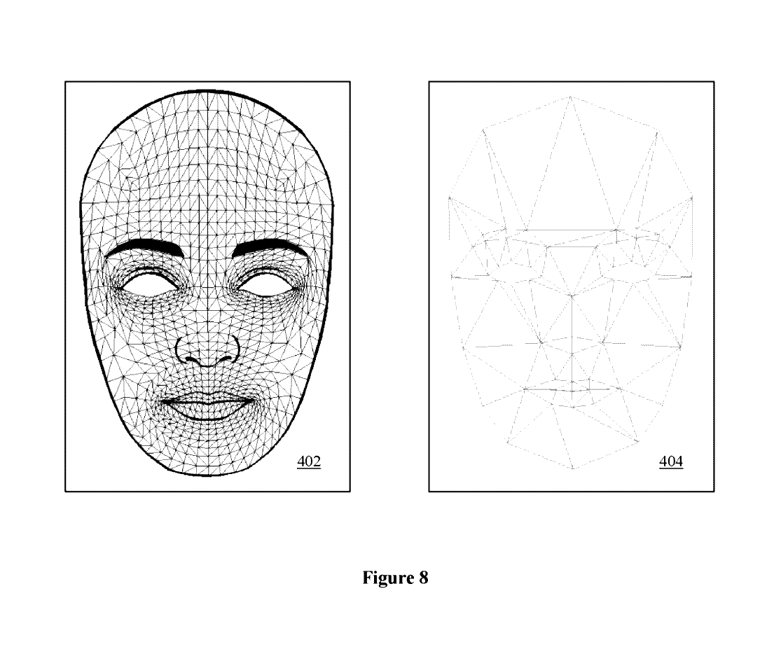

Referring now to FIGS. 7-8, wherein an example process for animating an avatar, including the dense and sparse meshes employed, according to various embodiments, is shown. As illustrated, process 300 for animating an avatar may include operations performed at block 312 and 314. Process 300 may be performed e.g., by earlier described avatar animation engine 104 of FIG. 1.

Process 300 may start at block 312. At block 312, a deformed mesh may be generated for the avatar to be animated, from the template mesh 302, and the blend shapes of the template mesh 302 may be transferred to the deformed mesh. In embodiments, the template mesh, and therefore, the deformed mesh, are dense meshes (similar to 402 of FIG. 8). Further, the texture uv coordinates of each vertex for the template mesh 302 may be set to be same as the location xy coordinates, and z set to zero. In other words, the template mesh 302, and therefore, the deformed mesh are effectively 2D meshes. In embodiments, the deformed mesh may be derived from the template mesh 302 using Radial Basis Function (RBF) interpolation. In embodiments, the blend shapes (such a brow up and down, eye close, mouth open, smile, etc.) may be transferred from the template mesh 302 onto the deform mesh, component by component, using a working sparse mesh (similar to 404 of FIG. 8). The sparse mesh (similar to 404 of FIG. 8) may be generated for the avatar via triangulation operations connecting the pre-defined landmarks. The operation may be performed e.g., using the Delaunay triangulation method. In embodiments, three hollow areas may be reserved in the sparse mesh for the left eye, right eye and the mouth, to animate normal eye and mouth movements.

Next, at block 314, on receipt of the facial expression and head pose parameters and blend shape weights 304, the blend shape weights may be applied, and the facial component movements as well as head rotations of the avatar may be calculated. In embodiments, as described earlier, the blend shapes may be applied as a linear blending operation as set forth by equation (1), which may be re-stated as

A*=A₀+Σᵢ₌₁^{N}αᵢ*ΔAᵢ (2)

where A* is the target mesh,
A₀ is the base mesh,
αᵢ is the blend shape weight of the ith blend shape,
ΔAᵢ is the i-th blend shape; and
N is the number of blend shapes.

In embodiments, to calculate the facial component movements of the avatar to be animated, the deformed mesh, which is a dense mesh (similar to 402 of FIG. 8), is overlaid on the earlier described sparse mesh (similar to 404 of FIG. 8) generated for the avatar. For each dense point of the dense mesh (402 of FIG. 8), 1) a key triangle on the sparse mesh (404 of FIG. 8) where the dense point is located in, may be identified; and 2) an interpolation coefficient may be determined for the dense point from the three vertex of the key triangle, using e.g., the barycenteric interpolation method. The interpolation coefficients may then be used to calculate the dense point movements, driven by the sparse key points.

In embodiments, in addition to facial component movements in a 2D plane, small angle head rotation may also be animated. Using the points along the face contour, the head of the user may be fitted to an ellipsoid, and set rz=rx, zc=0 (where rz means radius of z axis, zc means coordinate of ellipse center on z axis). The ellipsoid may be defined using equation (3):

$$\frac{{( x - {x}_{c} )}^{2}}{{r}_{x}^{2}} + \frac{{( y - {y}_{c} )}^{2}}{{r}_{y}^{2}} + \frac{{( z - {z}_{c} )}^{2}}{{r}_{z}^{2}} = 1$$

where x, y, z are the coordinates of a point on the ellipsoid,
x_{c}, y_{c}, z_{c}, are the coordinates of the center of the ellipsoid, and rₓ, r_{y}, r_{z} are the radii of the x, y and z axes.

Given a point with known x and y coordinate, the z value may be obtained using equation (3). On obtaining the z value, the 3D ellipsoid may be rotated to obtain the offset of each vertex. The offset may then be added to the dense deformed mesh with facial expression, and send to avatar rendering engine 106 for rendering.

In summary, after performing facial expression and head rotation, the animated data now include: 1) shape data, xyz coordinate of each vertex; 2) texture coordinate, uv; and 3) texture map of the customized avatar image. Avatar rendering engine may then send these data to e.g., a graphics processing unit (GPU) to render the animated 2D avatar model. Though the texture map is unchanged, the final display avatar is moveable because the dense deformed mesh vertex coordinate driven by facial and head movement may change from image frame to image frame.

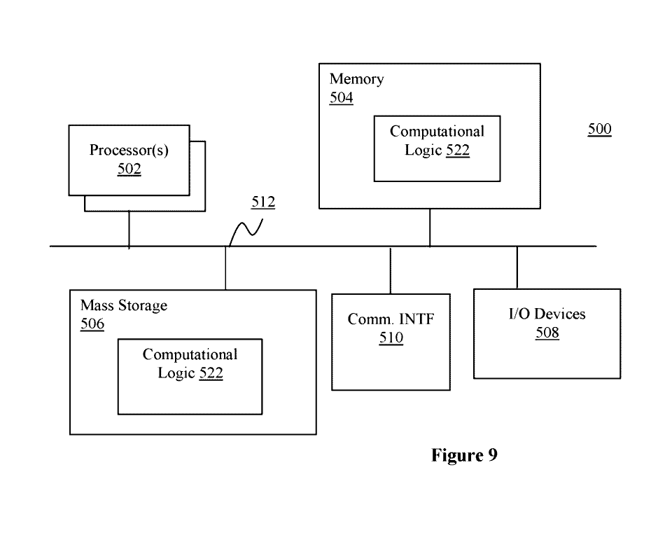

FIG. 9 illustrates an example computer system that may be suitable for use as a client device or a server to practice selected aspects of the present disclosure. As shown, computer 500 may include one or more processors or processor cores 502, and system memory 504. For the purpose of this application, including the claims, the term “processor” refers to physical processors, and the terms “processor” and “processor cores” may be considered synonymous, unless the context clearly requires otherwise. Additionally, computer 500 may include mass storage devices 506 (such as diskette, hard drive, compact disc read only memory (CD-ROM) and so forth), input/output devices 508 (such as display, keyboard, cursor control and so forth) and communication interfaces 510 (such as network interface cards, modems and so forth). The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage devices 506 may be employed to store a working copy and a permanent copy of the programming instructions implementing the operations associated with avatar generator 132, facial expression and head pose tracker 102, avatar animation engine 104, and/or avatar rendering engine 106, earlier described, and collectively referred to as computational logic 522. The various elements may be implemented by assembler instructions supported by processor(s) 502 or high-level languages, such as, for example, C, that can be compiled into such instructions.

The number, capability and/or capacity of these elements 510-512 may vary, depending on whether computer 500 is used as a client device or a server. When use as client device, the capability and/or capacity of these elements 510-512 may vary, depending on whether the client device is a stationary or mobile device, like a smartphone, computing tablet, ultrabook or laptop. Otherwise, the constitutions of elements 510-512 are known, and accordingly will not be further described.

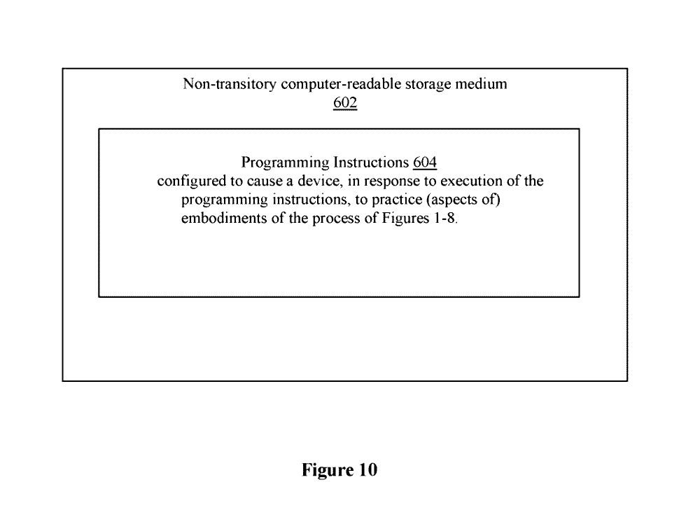

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 10 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., computer 500, in response to execution of the programming instructions, to perform, e.g., various operations associated with avatar generator 132, facial expression and head pose tracker 102, avatar animation engine 104, and/or avatar rendering engine 106. In alternate embodiments, programming instructions 604 may be disposed on multiple computer-readable non-transitory storage media 602 instead. In alternate embodiments, programming instructions 604 may be disposed on computer-readable transitory storage media 602, such as, signals.

Any combination of one or more computer usable or computer readable media may be utilized. The computer-usable or computer-readable medium/media may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium/media could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 9, for one embodiment, at least one of processors 502 may be packaged together with memory having computational logic 522 (in lieu of storing on memory 504 and storage 506). For one embodiment, at least one of processors 502 may be packaged together with memory having computational logic 522 to form a System in Package (SiP). For one embodiment, at least one of processors 502 may be integrated on the same die with memory having computational logic 522. For one embodiment, at least one of processors 502 may be packaged together with memory having computational logic 522 to form a System on Chip (SoC). For at least one embodiment, the SoC may be utilized in, e.g., but not limited to, a smartphone or computing tablet.

Thus various example embodiments of the present disclosure have been described including, but are not limited to:

Example 1 may be an apparatus for generating or animating an avatar, comprising: one or more processors; and an avatar generator to be operated by the processor to receive an image having a face of a user; analyze the image to identify various facial and related components of the user; access an avatar database to identify corresponding artistic renditions for the various facial and related components stored in the database; and combine the corresponding artistic renditions for the various facial and related components to form an avatar, without user intervention.

Example 2 may be example 1, wherein the avatar generator, as part of analysis of the image to identify various facial and related components of the user, may analyze the image to identify hair, face contour, brow, eye, nose, or mouth of the user; and wherein the avatar generator, as part of access of the avatar database, may identify corresponding artistic renditions for the hair, face contour, brow, eye, nose, or mouth identified.

Example 3 may be example 1, wherein the avatar generator, as part of analysis of the image to identify various facial and related components of the user, may analyze the image to identify color of skin, clothing or eye glasses of the user; and wherein the avatar generator may further form the avatar in view of the color of skin, clothing or eye glasses identified.

Example 4 may be example 1, wherein the avatar generator, as part of access of the avatar database, may first access the avatar database to identify corresponding similar reference facial and related component instances, based at least in part on the various facial and related components of the user; and then second access the database to identify the corresponding artistic renditions for the various facial and related components, based at least in part on the similar reference facial and related component instances.

Example 5 may be example 1, wherein the apparatus may further comprise the avatar database.

Example 6 may be any one of examples 1-5, further comprising a facial expression tracker to be operated by the processor to receive one or more additional images of a user; analyze the one or more additional images to identify facial expressions or head poses of the user; and generate a plurality of animation messages having a plurality of facial expression or head pose parameters that describe the facial expressions or head poses.

Example 7 may be example 6, further comprising an avatar animation engine to be operated by the processor to animate the avatar in accordance with the animation messages.

Example 8 may be example 7, wherein the avatar animation engine, as part of animation of the avatar, may generate a deformed mesh for the avatar, from a template mesh.

Example 9 may be example 8, wherein the template mesh and the deformed mesh are two-dimensional meshes.

Example 10 may be example 8, wherein the avatar animation engine, may further transfer a plurality of blend shapes associated with the template mesh to the deformed mesh.

Example 11 may be example 10, wherein the avatar animation engine, may further linearly apply a plurality of blend shape weights included in the animation messages to the blend shapes.

Example 12 may be example 8, wherein the avatar animation engine may further generate a dense mesh that incorporates movement information included in the animation messages for a plurality of landmarks for one or more facial components, using the deformed mesh.

Example 13 may be example 12, wherein for each dense point on the dense mesh, the avatar animation engine may determine which triangle of the deformed mesh the dense point is located in, and calculate an interpolation coefficient for the dense point based at least in part on vertices of the triangle.

Example 14 may be example 6, wherein the apparatus is a selected one of a smartphone, a computing tablet, an ultrabook, an ebook, or a laptop computer.

Example 15 may be a method for generating or animating an avatar, comprising: receiving, by a computing device, an image having a face of a user; analyzing, by the computing device, the image to identify various facial and related components of the user; accessing, by the computing device, an avatar database to identify corresponding artistic renditions for the various facial and related components stored in the database; and combining, by the computing device, the corresponding artistic renditions for the various facial and related components to form an avatar, without user intervention.

Example 16 may be example 15, wherein analyzing may comprise analyzing the image to identify hair, face contour, brow, eye, nose, or mouth of the user; and wherein accessing may comprise identifying corresponding artistic renditions for the hair, face contour, brow, eye, nose, or mouth identified.

Example 17 may be example 15, wherein analyzing may comprise analyzing the image to identify color of skin, clothing or eye glasses of the user; and wherein combining may comprise forming the avatar in view of the color of skin, clothing or eye glasses identified.

Example 18 may be example 15, wherein accessing may comprise first accessing the avatar database to identify corresponding similar reference facial and related component instances, based at least in part on the various facial and related components of the user; and then second accessing the database to identify the corresponding artistic renditions for the various facial and related components, based at least in part on the similar reference facial and related component instances.

Example 19 may be any one of examples 15-18, further comprising receiving, by the computing device, one or more additional images of a user; analyzing, by the computing device, the one or more additional images to identify facial expressions or head poses of the user; and generating, by the computing device, a plurality of animation messages having a plurality of facial expression or head pose parameters that describe the facial expressions or head poses.

Example 20 may be example 19, further comprising animating, by the computing device, the avatar in accordance with the animation messages.

Example 21 may be example 20, wherein animating may comprise generating a deformed mesh for the avatar, from a template mesh.

Example 22 may be example 21, wherein animating may further comprise transferring, a plurality of blend shapes associated with the template mesh to the deformed mesh.

Example 23 may be example 22, wherein animating may further comprise linearly applying, by the computing device, a plurality of blend shape weights included in the animation messages to the blend shapes.

Example 24 may be example 21, wherein animating may further comprise generating a dense mesh that incorporates movement information included in the animation messages for a plurality of landmarks for one or more facial components, using the deformed mesh.

Example 25 may be example 24, wherein generating a dense mesh may comprise determining, for each dense point on the dense mesh, which triangle of the deformed mesh the dense point is located in, and calculate an interpolation coefficient for the dense point based at least in part on vertices of the triangle.

Example 26 may be one or more computer-readable media comprising instructions that cause an computing device, in response to execution of the instructions by the computing device, to operate an avatar generator to: receive an image having a face of a user; analyze the image to identify various facial and related components of the user; access an avatar database to identify corresponding artistic renditions for the various facial and related components stored in the database; and combine the corresponding artistic renditions for the various facial and related components to form an avatar, without user intervention.

Example 27 may be example 26, wherein the avatar generator, as part of analysis of the image to identify various facial and related components of the user, may analyze the image to identify hair, face contour, brow, eye, nose, or mouth of the user; and wherein the avatar generator, as part of access of the avatar database, may identify corresponding artistic renditions for the hair, face contour, brow, eye, nose, or mouth identified.

Example 28 may be example 26, wherein the avatar generator, as part of analysis of the image to identify various facial and related components of the user, may analyze the image to identify color of skin, clothing or eye glasses of the user; and wherein the avatar generator may further form the avatar in view of the color of skin, clothing or eye glasses identified.

Example 29 may be example 26, wherein the avatar generator, as part of access of the avatar database, may first access the avatar database to identify corresponding similar reference facial and related component instances, based at least in part on the various facial and related components of the user; and then second access the database to identify the corresponding artistic renditions for the various facial and related components, based at least in part on the similar reference facial and related component instances.

Example 30 may be example 26-29, wherein the instructions, in response to execution by the computing device, further cause the computing device to operate a facial expression tracker to receive one or more additional images of a user; analyze the one or more additional images to identify facial expressions or head poses of the user; and generate a plurality of animation messages having a plurality of facial expression or head pose parameters that describe the facial expressions or head poses.

Example 31 may be example 30, wherein the instructions, in response to execution by the computing device, further cause the computing device to operate an avatar animation engine to be operated by the processor to animate the avatar in accordance with the animation messages.

Example 32 may be example 31, wherein the avatar animation engine, as part of animation of the avatar, may generate a deformed mesh for the avatar, from a template mesh.

Example 33 may be example 32, wherein the avatar animation engine, may further transfer a plurality of blend shapes associated with the template mesh to the deformed mesh.

Example 34 may be example 33, wherein the avatar animation engine, may further linearly apply a plurality of blend shape weights included in the animation messages to the blend shapes.

Example 35 may be example 32, wherein the avatar animation engine may further generate a dense mesh that incorporates movement information included in the animation messages for a plurality of landmarks for one or more facial components, using the deformed mesh.

Example 36 may be example 35, wherein for each dense point on the dense mesh, the avatar animation engine may determine which triangle of the deformed mesh the dense point is located in, and calculate an interpolation coefficient for the dense point based at least in part on vertices of the triangle.

Example 37 may be an apparatus for generating or animating an avatar, comprising: means for receiving an image having a face of a user; means for analyzing the image to identify various facial and related components of the user; means for accessing, an avatar database to identify corresponding artistic renditions for the various facial and related components stored in the database; and means for combining, the corresponding artistic renditions for the various facial and related components to form an avatar, without user intervention.

Example 38 may be example 37, wherein means for analyzing may comprise means for analyzing the image to identify hair, face contour, brow, eye, nose, or mouth of the user; and wherein means for accessing may comprise means for identifying corresponding artistic renditions for the hair, face contour, brow, eye, nose, or mouth identified.

Example 39 may be example 37, wherein means for analyzing may comprise means for analyzing the image to identify color of skin, clothing or eye glasses of the user; and wherein means for combining may comprise means for forming the avatar in view of the color of skin, clothing or eye glasses identified.

Example 40 may be example 37, wherein means for accessing may comprise means for first accessing the avatar database to identify corresponding similar reference facial and related component instances, based at least in part on the various facial and related components of the user; and means for second accessing the database to identify the corresponding artistic renditions for the various facial and related components, based at least in part on the similar reference facial and related component instances.

Example 41 may be example 37-40, further comprising means for receiving one or more additional images of a user; means for analyzing, the one or more additional images to identify facial expressions or head poses of the user; and means for generating a plurality of animation messages having a plurality of facial expression or head pose parameters that describe the facial expressions or head poses.

Example 42 may be example 41, further comprising means for animating the avatar in accordance with the animation messages.

Example 43 may be example 42, wherein means for animating may comprise means for generating a deformed mesh for the avatar, from a template mesh.

Example 44 may be example 43, wherein means for animating may further comprise means for transferring a plurality of blend shapes associated with the template mesh to the deformed mesh.

Example 45 may be example 44, wherein means for animating may further comprise means for linearly applying a plurality of blend shape weights included in the animation messages to the blend shapes.

Example 46 may be example 43, wherein means for animating may further comprise means for generating a dense mesh that incorporates movement information included in the animation messages for a plurality of landmarks for one or more facial components, using the deformed mesh.

Example 47 may be example 46, wherein means for generating a dense mesh that incorporates movement information may comprise means for determining, for each dense point on the dense mesh, which triangle of the deformed mesh the dense point is located in, and calculate an interpolation coefficient for the dense point based at least in part on vertices of the triangle.

Example 48 may be an apparatus for generating or animating an avatar, comprising: one or more processors; and an avatar animation engine to be operated by the processor to animate the avatar in accordance with a plurality of animation messages having facial expression or head pose parameters that describe facial expressions or head poses of a user determined from one or more images of the user; wherein the avatar animation engine, as part of animation of the avatar, may generate a deformed mesh for the avatar, from a template mesh; and transfer a plurality of blend shapes associated with the template mesh to the deformed mesh.

Example 49 may be example 48, wherein the template mesh and the deformed mesh are two-dimensional meshes.

Example 50 may be example 48, wherein the avatar animation engine, may further linearly apply a plurality of blend shape weights included in the animation messages to the blend shapes.

Example 51 may be example 48-50, wherein the avatar animation engine may further generate a dense mesh that incorporates movement information included in the animation messages for a plurality of landmarks for one or more facial components, using the deformed mesh.

Example 52 may be example 51, wherein for each dense point on the dense mesh, the avatar animation engine may determine which triangle of the deformed mesh the dense point is located in, and calculate an interpolation coefficient for the dense point based at least in part on vertices of the triangle.

Example 53 may be a method for generating or animating an avatar, comprising: receiving, by a computing device, a plurality of animation messages having facial expression or head pose parameters that describe facial expressions or head poses of a user determined from one or more images of the user; and animating, by the computing device, the avatar in accordance with the plurality of animation messages; wherein animating includes generating a deformed mesh for the avatar, from a template mesh; and transferring a plurality of blend shapes associated with the template mesh to the deformed mesh.

Example 54 may be example 53, wherein animating may further comprise linearly applying a plurality of blend shape weights included in the animation messages to the blend shapes.

Example 55 may be any one of examples 53-54, wherein animating may further comprise generating a dense mesh that incorporates movement information included in the animation messages for a plurality of landmarks for one or more facial components, using the deformed mesh.

Example 56 may be example 55, wherein generating a dense mesh may comprise, for each dense point on the dense mesh, determining which triangle of the deformed mesh the dense point is located in, and calculating an interpolation coefficient for the dense point based at least in part on vertices of the triangle.

Example 57 may be one or more computer-readable media comprising instructions that cause an computing device, in response to execution of the instructions by the computing device, to: operate an avatar animation engine to animate an avatar in accordance with a plurality of animation messages having facial expression or head pose parameters that describe facial expressions or head poses of a user determined from one or more images of the user; wherein the avatar animation engine, as part of animation of the avatar, may generate a deformed mesh for the avatar, from a template mesh; and transfer a plurality of blend shapes associated with the template mesh to the deformed mesh.

Example 58 may be example 57, wherein the avatar animation engine, may further linearly apply a plurality of blend shape weights included in the animation messages to the blend shapes.

Example 59 may be any one of examples 57-58, wherein the avatar animation engine may further generate a dense mesh that incorporates movement information included in the animation messages for a plurality of landmarks for one or more facial components, using the deformed mesh.

Example 60 may be example 59, wherein for each dense point on the dense mesh, the avatar animation engine may determine which triangle of the deformed mesh the dense point is located in, and calculate an interpolation coefficient for the dense point based at least in part on vertices of the triangle.

Example 61 may be an apparatus for generating or animating an avatar, comprising: means for receiving a plurality of animation messages having facial expression or head pose parameters that describe facial expressions or head poses of a user determined from one or more image of the user; and means for animating the avatar in accordance with the plurality of animation messages; wherein means for animating include means for generating a deformed mesh for the avatar, from a template mesh; and means for transferring a plurality of blend shapes associated with the template mesh to the deformed mesh.

Example 62 may be example 61, wherein means for animating further include means for linearly applying a plurality of blend shape weights included in the animation messages to the blend shapes.

Example 63 may be example 61 or 62, wherein means for animating further include means for generating a dense mesh that incorporates movement information included in the animation messages for a plurality of landmarks for one or more facial components, using the deformed mesh.

Example 64 may be example 63, wherein means generating a dense mesh include, for each dense point on the dense mesh, determining which triangle of the deformed mesh the dense point is located in, and calculating an interpolation coefficient for the dense point based at least in part on vertices of the triangle.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claim and its equivalents.

1. An apparatus for generating or animating an avatar, comprising:
one or more processors; and
an avatar generator to be operated by the processor to receive an image having a face of a user; analyze the image to identify various facial and related components of the user; access an avatar database to identify corresponding artistic renditions for the various facial and related components stored in the database; and combine the corresponding artistic renditions for the various facial and related components to form an avatar, without user intervention.

2. The apparatus of claim 1, wherein the avatar generator, as part of analysis of the image to identify various facial and related components of the user, is to analyze the image to identify hair, face contour, brow, eye, nose, or mouth of the user; and wherein the avatar generator, as part of access of the avatar database, is to identify corresponding artistic renditions for the hair, face contour, brow, eye, nose, or mouth identified.

3. The apparatus of claim 1, wherein the avatar generator, as part of analysis of the image to identify various facial and related components of the user, is to analyze the image to identify color of skin, clothing or eye glasses of the user; and wherein the avatar generator is to further form the avatar in view of the color of skin, clothing or eye glasses identified.

4. The apparatus of claim 1, wherein the avatar generator, as part of access of the avatar database, is to first access the avatar database to identify corresponding similar reference facial and related component instances, based at least in part on the various facial and related components of the user; and then second access the database to identify the corresponding artistic renditions for the various facial and related components, based at least in part on the similar reference facial and related component instances.

5. The apparatus of claim 1, wherein the apparatus further comprises the avatar database.

6. The apparatus of claim 1, further comprising a facial expression tracker to be operated by the processor to receive one or more additional images of a user; analyze the one or more additional images to identify facial expressions or head poses of the user; and generate a plurality of animation messages having a plurality of facial expression or head pose parameters that describe the facial expressions or head poses.

7. The apparatus of claim 6, further comprising an avatar animation engine to be operated by the processor to animate the avatar in accordance with the animation messages.

8. The apparatus of claim 7, wherein the avatar animation engine, as part of animation of the avatar, is to generate a deformed mesh for the avatar, from a template mesh.

9. The apparatus of claim 8, wherein the template mesh and the deformed mesh are two-dimensional meshes.

10. The apparatus of claim 8, wherein the avatar animation engine, is to further transfer a plurality of blend shapes associated with the template mesh to the deformed mesh.

11. The apparatus of claim 10, wherein the avatar animation engine, is to further linearly apply a plurality of blend shape weights included in the animation messages to the blend shapes.

12. The apparatus of claim 8, wherein the avatar animation engine is to further generate a dense mesh that incorporates movement information included in the animation messages for a plurality of landmarks for one or more facial components, using the deformed mesh.

13. The apparatus of claim 12, wherein for each dense point on the dense mesh, the avatar animation engine is to determine which triangle of the deformed mesh the dense point is located in, and calculate an interpolation coefficient for the dense point based at least in part on vertices of the triangle.

14. The apparatus of claim 6, wherein the apparatus is a selected one of a smartphone, a computing tablet, an ultrabook, an ebook, or a laptop computer.

15. A method for generating or animating an avatar, comprising:
receiving, by a computing device, an image having a face of a user;
analyzing, by the computing device, the image to identify various facial and related components of the user;
accessing, by the computing device, an avatar database to identify corresponding artistic renditions for the various facial and related components stored in the database; and
combining, by the computing device, the corresponding artistic renditions for the various facial and related components to form an avatar, without user intervention.

16. The method of claim 15, wherein analyzing comprises analyzing the image to identify hair, face contour, brow, eye, nose, or mouth of the user; and wherein accessing comprises identifying corresponding artistic renditions for the hair, face contour, brow, eye, nose, or mouth identified.

17. The method of claim 15, wherein analyzing comprises analyzing the image to identify color of skin, clothing or eye glasses of the user; and wherein combining comprises forming the avatar in view of the color of skin, clothing or eye glasses identified.

18. (canceled)

19. The method of claim 15, further comprising
receiving, by the computing device, one or more additional images of a user; analyzing, by the computing device, the one or more additional images to identify facial expressions or head poses of the user; and generating, by the computing device, a plurality of animation messages having a plurality of facial expression or head pose parameters that describe the facial expressions or head poses; and
animating, by the computing device, the avatar in accordance with the animation messages;
wherein animating comprises generating a deformed mesh for the avatar, from a template mesh, and transferring a plurality of blend shapes associated with the template mesh to the deformed mesh.

20. (canceled)

21. (canceled)

22. (canceled)

23. (canceled)

24. (canceled)

25. (canceled)

26. One or more computer-readable media comprising instructions that cause an computing device, in response to execution of the instructions by the computing device, to operate an avatar generator to:
receive an image having a face of a user; analyze the image to identify various facial and related components of the user; access an avatar database to identify corresponding artistic renditions for the various facial and related components stored in the database; and combine the corresponding artistic renditions for the various facial and related components to form an avatar, without user intervention.

27. The one or more computer-readable media of claim 26, wherein the avatar generator, as part of analysis of the image to identify various facial and related components of the user, is to analyze the image to identify hair, face contour, brow, eye, nose, or mouth of the user; and wherein the avatar generator, as part of access of the avatar database, is to identify corresponding artistic renditions for the hair, face contour, brow, eye, nose, or mouth identified.

28. The one or more computer-readable media of claim 26, wherein the avatar generator, as part of analysis of the image to identify various facial and related components of the user, is to analyze the image to identify color of skin, clothing or eye glasses of the user; and wherein the avatar generator is to further form the avatar in view of the color of skin, clothing or eye glasses identified.

29. The one or more computer-readable media of claim 26, wherein the avatar generator, as part of access of the avatar database, is to first access the avatar database to identify corresponding similar reference facial and related component instances, based at least in part on the various facial and related components of the user; and then second access the database to identify the corresponding artistic renditions for the various facial and related components, based at least in part on the similar reference facial and related component instances.

30. The one or more computer-readable media of claim 26, wherein the instructions, in response to execution by the computing device, further cause the computing device to operate a facial expression tracker to receive one or more additional images of a user; analyze the one or more additional images to identify facial expressions or head poses of the user; and generate a plurality of animation messages having a plurality of facial expression or head pose parameters that describe the facial expressions or head poses; and wherein the instructions, in response to execution by the computing device, further cause the computing device to operate an avatar animation engine to be operated by the processor to animate the avatar in accordance with the animation messages, wherein the avatar animation engine, as part of animation of the avatar, is to generate a deformed mesh for the avatar, from a template mesh, and transfer a plurality of blend shapes associated with the template mesh to the deformed mesh.

31. The one or more computer-readable media of claim 30, wherein the avatar animation engine, is to further linearly apply a plurality of blend shape weights included in the animation messages to the blend shapes.

32. The one or more computer-readable media of claim 31, wherein the avatar animation engine is to further generate a dense mesh that incorporates movement information included in the animation messages for a plurality of landmarks for one or more facial components, using the deformed mesh; wherein for each dense point on the dense mesh, the avatar animation engine is to determine which triangle of the deformed mesh the dense point is located in, and calculate an interpolation coefficient for the dense point based at least in part on vertices of the triangle.
